(19) United States
(12) Patent Application Publication
(10) Pub. No.: US 2013/0239014 A1
(43) Pub. Date: Sep. 12, 2013

(54) FILE TRANSFER METHODOLOGY FOR A DESKTOP SHARING SYSTEM

(71) Applicant: Dipak Patil, Miraj (IN)

(72) Inventor: Dipak Patil, Miraj (IN)

(73) Assignee: SALESFORCE.COM, INC., San Francisco, CA (US)

(21) Appl. No.: 13/414,426

(22) Filed: Mar. 7, 2012

(51) Int. Cl. G06F 3/01

(52) U.S. Cl. 715/748

(57) ABSTRACT

A computer-implemented system and related operating methods are provided. The system has a plurality of devices including at least a publisher device and a viewer device. On operating method of the system begins by initiating a desktop sharing session between the publisher device and the viewer device. The method continues by establishing a data communication connection between the publisher device and the viewer device to support the desktop sharing session, wherein virtual display data representing displayed content of the publisher device is received by the viewer device using the data communication connection. During the desktop sharing session, the a copy of a designated item is received at the viewer device via the data communication connection, wherein the designated item is shared by the publisher device.

### TECHNICAL FIELD

Embodiments of the subject matter described herein relate generally to computer and network systems that support desktop sharing between remote participants. More specifically, the subject matter relates to a file sharing methodology that allows the user of the computer system with the shared display (i.e., the “publisher”) to quickly and easily share files with those viewing the shared display (i.e., the “viewers”).

### BACKGROUND

Desktop sharing applications are known in the art. A desktop sharing application allows one user (known as the Publisher) to share the displayed content of his or her monitor screen with one or more remote users (known as the Viewers) via a network architecture such as the Internet. The Publisher and the Viewers are typically required to install software, a plug-in, or other code that accommodates that desktop sharing functionality. When activated, the Viewers are able to see the content and display of the Publisher's monitor in substantially real time. At times, the Publisher may want to share, distribute, or transfer a file to the Viewers. Traditionally, file transfer is accomplished by accessing an appropriate feature or application on the host machine that is distinct and different from the desktop sharing application. For example, the Publisher may need to attach the file to an email and then send the email to all of the Viewers. Alternatively, the Publisher may need to upload the file to a file transfer protocol (FTP) site for retrieval by the Viewers. Similarly, the Viewers may need to launch, access, or otherwise manipulate one or more applications to download or receive the desired content. This type of workflow can be time consuming, complicated, and inconvenient.

Accordingly, it is desirable to have an efficient and effective mode of transferring files within a desktop sharing environment. Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an exemplary embodiment of a computer-implemented system capable of supporting a desktop sharing application;

FIG. 2 is a schematic representation of an exemplary embodiment of an apparatus suitable for use in a system such as that depicted in FIG. 1;

FIG. 3A and FIG. 3B are flow charts that illustrate an exemplary embodiment of a data sharing process;

FIG. 4 is a schematic representation of an exemplary context menu that could be used to initiate a desktop sharing file transfer procedure;

FIG. 5 is a schematic representation of an exemplary sharing control element that could be used to share a file, folder, or other item during a desktop sharing session; and

FIG. 6 is a schematic representation of an exemplary embodiment of a multi-tenant application system.

### DETAILED DESCRIPTION

The exemplary embodiments presented here relate to a computer-implemented desktop sharing system and related processes, which may be deployed with desktop computers, laptop computers, mobile devices, or the like. The system supports a quick, easy, and convenient mode of transferring files from the host or publisher device (referred to herein as the “Publisher”) to one or more recipients or viewer devices (referred to herein as the “Viewers”).

Many people use a desktop sharing and display feature during live meetings with remote participants, and sometimes throughout the day for normal day to day activities. A desktop sharing application allows remote Viewers to view the display of a host Publisher in substantially real time. Historically, file transfers from a Publisher to a Viewer (and vice versa) during a desktop sharing session require additional applications or technologies such as file transport protocol (FTP), secure shell (SSH) services, email, or the like. Unfortunately, this mode of file transfer can consume lots of time during a live meeting: the participants will need to launch, access, and download files using various applications. Moreover, if there are multiple Viewers, then the Publisher will need to send a shared file to a plurality of different destinations. Accordingly, in an email-dependent system, the Publisher will have to open or access an email application, open a new email, add all the participants to the outgoing email, attach the desired file, and then send the email. Moreover, all of the Viewers will need to open their email applications and access or open the file. This process can take several minutes of time for each shared file. If a file is too large, then the email facility may not accept it—in such a scenario, the users will need to use a web sharing site, an FTP site, or something equivalent to share the file to the users. This scenario can be problematic if access to the sharing site is restricted or limited and all of the Viewers cannot access the uploaded file.

The system described here addresses these shortcomings by providing a feature and functionality to send a file, a folder, data, or any item of interest to one or more remote participants directly during a desktop sharing session. In accordance with one embodiment, the Publisher device is provided with a context menu (e.g., a menu option that appears when the Publisher right-clicks on a file, a folder, some selected text, or the like). This context menu includes an option to “Send To Participants” or “Select Participants For File Sharing” during the desktop sharing session. Activation of this option will cause the Publisher device to transfer the selected file or content to the selected Viewers in a “direct” manner using the established data connections that are already being used by the desktop sharing application, and without having to launch or access any other data communication applications.

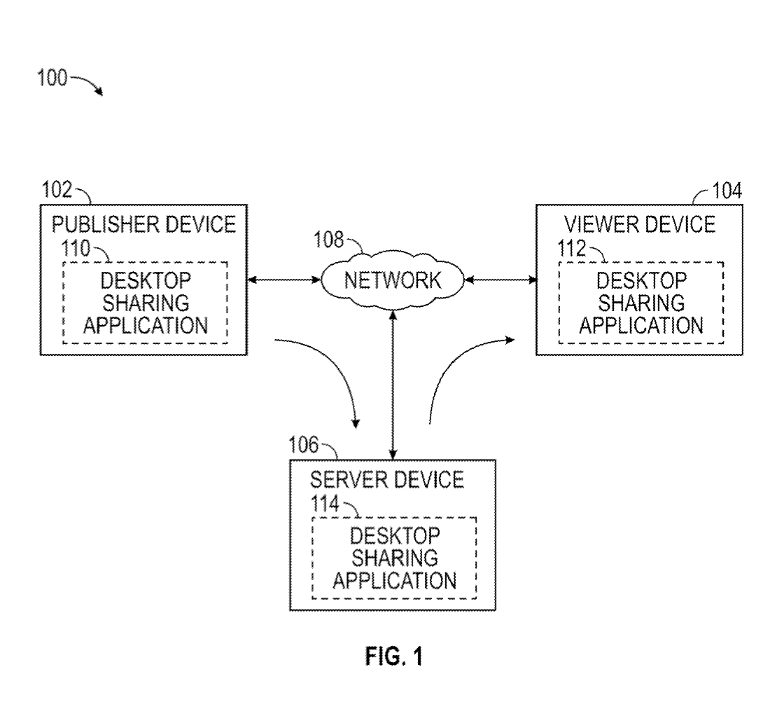

FIG. 1 is a schematic representation of an exemplary embodiment of a computer-implemented system 100 that is suitable for use in a desktop sharing mode. This particular embodiment of the system 100 includes a publisher device 102, at least one viewer device 104 (only one is shown for simplicity), and a server device, infrastructure, system, or architecture 106. The primary components of the system 100 may communicate with one another using a suitably configured data communication network 108. The system 100 is preferably realized as a computer-implemented system in that the publisher device 102, the viewer device 104, and the server device 106 are configured as computer-based or processor-based electronic devices.

Although only one viewer device 104 is shown in FIG. 1, an embodiment of the system 100 could support any number of viewer devices 104 that are each capable of sharing the desktop display of the publisher device 102. Each user device supported by the system 100 may be implemented using any suitable hardware platform. In this regard, the publisher device and the viewer device 104 may be realized in any common form factor including, without limitation: a desktop computer; a mobile computer (e.g., a tablet computer, a laptop computer, or a netbook computer); a smartphone; a video game device; a digital media player; a piece of home entertainment equipment; or the like. The components of the system 100 are suitably configured, programmed, and designed to accommodate the various display, networking, data communication, and data processing features and functions that are needed to support the operation of the system 100 as described in detail here.

The publisher device 102 represents the device that is sharing its display monitor with the viewer device 104. Conversely, the viewer device 104 represents the device that is able to view the shared screen provided by the publisher device 102. In certain embodiments, the server device 106 can be used as an interface between the publisher device 102 and the viewer devices 104. For such embodiments, the publisher device 102 sends data (e.g., virtual display data and shared files) to the server device 106, which in turn sends data to the viewer device 104. Alternatively, the publisher device 102 could send data “directly” to the viewer device 104 via the data communication network 108.

The server device 106 can be deployed in certain embodiments of the system 100 to manage, handle, and/or serve some or all of the display sharing and content sharing functionality for the publisher device 102. In practice, the server device 106 may be realized as a computer-implemented or computer-based system having the hardware, software, firmware, and/or processing logic needed to carry out the various processes, techniques, and methodologies described in more detail herein. It should be appreciated that the server device 106 need not be deployed in embodiments where the publisher device 102 and the viewer device 104 cooperate to perform the desired functionality.

The data communication network 108 provides and supports data connectivity between the publisher device 102, the viewer device 104, and the server device 106. In practice, the data communication network 108 may be any digital or other communications network capable of transmitting messages or data between devices, systems, or components. In certain embodiments, the data communication network 108 includes a packet switched network that facilitates packet-based data communication, addressing, and data routing. The packet switched network could be, for example, a wide area network, the Internet, or the like. In various embodiments, the data communication network 108 includes any number of public or private data connections, links or network connections supporting any number of communications protocols. The data communication network 108 may include the Internet, for example, or any other network based upon TCP/IP or other conventional protocols. In various embodiments, the data communication network 108 could also incorporate a wireless and/or wired telephone network, such as a cellular communications network for communicating with mobile phones, personal digital assistants, and/or the like. The data communication network 108 may also incorporate any sort of wireless or wired local and/or personal area networks, such as one or more IEEE 802.3, IEEE 802.16, and/or IEEE 802.11 networks, and/or networks that implement a short range (e.g., Bluetooth) protocol.

Each of the main components depicted in FIG. 1 may include or cooperate with a suitably configured desktop sharing application 110, 112, 114 that supports the desktop file sharing techniques, technologies, and functions described here. The desktop sharing application 110 resident at the publisher device and the desktop sharing application 112 resident at the viewer device 104 are responsible for initiating and maintaining desktop sharing sessions between the publisher device 102 and the viewer device 104. Moreover, the desktop sharing application 110 resident at the publisher device 102 may be responsible for generating and displaying certain graphical user interface (GUI) elements that facilitate the file sharing techniques described here. Similarly, the desktop sharing application 112 resident at the viewer device 104 may be responsible for receiving and saving shared files for the viewer device 104. In certain embodiments, one or more of the desktop sharing applications 110, 112, 114 can be utilized to establish and maintain data communication connections between the publisher device 102 and the viewer device 104, where the data communication connections are used to transfer virtual display data and shared content from the publisher device 102 to the viewer device 104.

In certain implementations, desktop screen sharing is achieved using a suitable transport layer (e.g., Secure Sockets Layer) or using a suitable transfer protocol such as the Hypertext Transfer Protocol. As described in more detail below, when the user of the publisher device 102 decides to share or send an item (such as a file or a folder) during a desktop sharing session, the system 100 uses the shared data channel to accommodate the file transfer. Alternatively, the publisher device 102 can send the file data over an existing channel with predefined metadata that identifies that the data packets are related to designated shared file data. The file data can be sent to the server device 106 using the existing desktop sharing connections in the form of packets, as is well understood. The server device 106 opens the data channel to the viewer device 104 (or on an existing channel with metadata specific to the file) and sends the files/folder to the viewer device 104, and to any other viewer devices identified by the publisher device 102. Alternatively, a notification can be sent to the viewer device 104 to give the user of the viewer device 104 the opportunity to accept the file transfer and to initiate a download of the shared file at a convenient time.

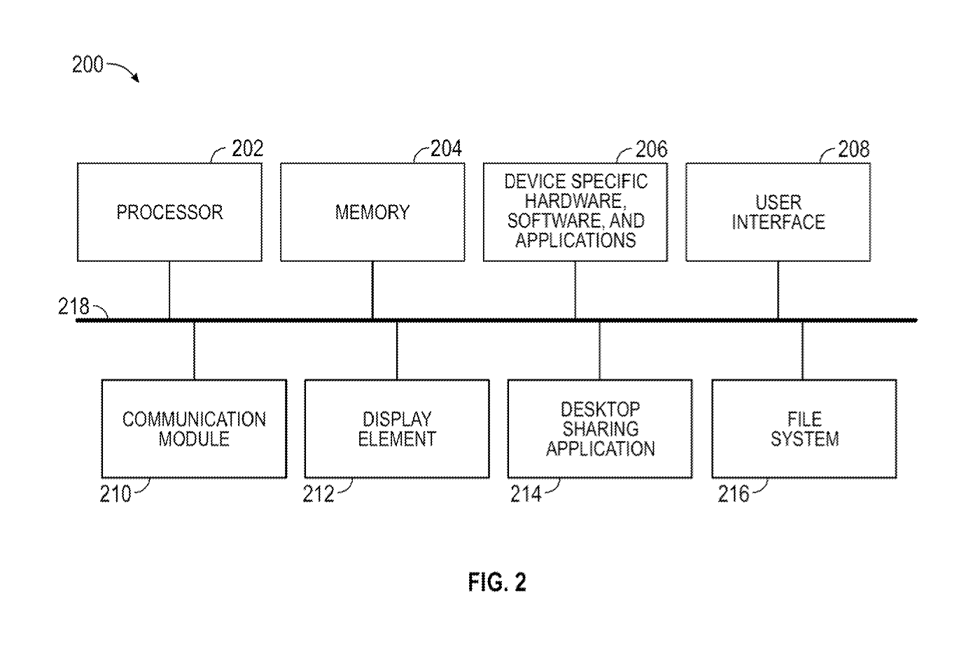

FIG. 2 is a schematic representation of an exemplary embodiment of an apparatus, system, or device 200 suitable for use in a system such as that depicted in FIG. 1. In practice, the publisher device 102, the viewer device 104, and the server device 106 could be generally configured and implemented as shown in FIG. 2. Thus, the following general description of the device 200 may be applicable to any of the main components of the system 100 shown in FIG. 1.

The illustrated embodiment of the device 200 includes, without limitation: at least one processor 202; a suitable amount of memory 204; device-specific hardware, software, firmware, and/or applications 206; a user interface 208; a communication module 210; a display element 212; a desktop sharing application 214; and a file system 216. Of course, the device 200 may include additional elements, components, modules, and functionality configured to support various features that are unrelated to the subject matter described here. For example, the device 200 may include certain features and elements to support conventional functions that might be related to the particular implementation and deployment of the device 200. In practice, the elements of the device 200 may be coupled together via a bus or any suitable interconnection architecture 218.

The processor 202 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. A processor may be realized as a microprocessor, a controller, a microcontroller, or a state machine. Moreover, a processor may be implemented as a combination of computing devices, e.g., a combination of a digital signal processor and a microprocessor, a plurality of microprocessors, one or more microprocessors in conjunction with a digital signal processor core, or any other such configuration.

The memory 204 may be realized as RAM memory, flash memory, EPROM memory, EEPROM memory, registers, a hard disk, a removable disk, a CD-ROM, or any other form of storage medium known in the art. In this regard, the memory 204 can be coupled to the processor 202 such that the processor 202 can read information from, and write information to, the memory 204. In the alternative, the memory 204 may be integral to the processor 202. As an example, the processor 202 and the memory 204 may reside in an ASIC. The memory 204 can be used to store computer-readable media, where a tangible computer-readable medium has computer-executable instructions stored thereon (accordingly, the computer-readable medium is typically non-transitory in nature). The computer-executable instructions, when read and executed by the device 200, cause the device 200 to perform certain tasks, operations, functions, and processes described in more detail herein. In this regard, the memory 204 may represent one suitable implementation of such computer-readable media. Alternatively or additionally, the device 200 could receive and cooperate with computer-readable media (not separately shown) that is realized as a portable or mobile component or platform, e.g., a portable hard drive, a USB flash drive, an optical disc, or the like.

The device-specific hardware, software, firmware, and applications 206 may vary from one embodiment of the device 200 to another. For example, the device-specific hardware, software, firmware, and applications 206 will support telephone functions and features when the device 200 is realized as a mobile telephone, conventional personal computer functions and features if the device 200 is realized as a desktop or portable computer, and server functions and features if the device 200 is realized as a server device (including, in certain embodiments, web server functionality). In practice, certain portions or aspects of the device-specific hardware, software, firmware, and applications 206 may be implemented in one or more of the other blocks depicted in FIG. 2.

The user interface 208 may include or cooperate with various features to allow a user to interact with the device 200. Accordingly, the user interface 208 may include various human-to-machine interfaces, e.g., a keypad, keys, a keyboard, buttons, switches, knobs, a touchpad, a joystick, a pointing device, a virtual writing tablet, a touch screen, a microphone, or any device, component, or function that enables the user to select options, input information, or otherwise control the operation of the device 200. In various embodiments, the user interface 208 may include one or more graphical user interface (GUI) control elements that enable a user to manipulate or otherwise interact with an application via the display element 212. In this regard, the user interface 208 allows the user of a publisher device to interact with and manipulate context menus, dropdown menus, selectable radio buttons, sharing control elements, and other GUI features described in more detail below.

The communication module 210 facilitates data communication between the device 200 and other components as needed during the operation of the device 200. In the context of this description, the communication module 210 can be employed during a desktop sharing session that includes the device 200 as one of the participant devices. Thus, the communication module 210 may be responsible for providing virtual display data from the publisher device to the viewer devices, and for providing copies of shared items (e.g., files, executables, or folders) from the publisher device to the viewer devices. An embodiment of the device 200 may support wireless data communication and/or wired data communication, using various data communication protocols. For example, the communication module could support one or more wireless data communication protocols, techniques, or methodologies, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB. Moreover, the communication module could support one or more wired/cabled data communication protocols, including, without limitation: Ethernet; home network communication protocols; USB; IEEE 1394 (Firewire); hospital network communication protocols; and proprietary data communication protocols.

The display element 212 is suitably configured to enable the device 200 to render and display various screens, GUIs, GUI control elements, drop down menus, auto-fill fields, text entry fields, message fields, or the like. Of course, the display element 212 may also be utilized for the display of other information during the operation of the device 200, as is well understood. Notably, the specific configuration, operating characteristics, size, resolution, and functionality of the display element 212 can vary depending upon the practical implementation of the device 200. For example, if the device 200 is a desktop computer, then the display element 212 may be a relatively large monitor. Alternatively, if the device 200 is a cellular telephone device, then the display element 212 may be a relatively small integrated display screen, which may be realized as a touch screen.

The desktop sharing application 214 may refer to hardware, software, firmware, and/or processing logic that supports one or more desktop (display) sharing technologies utilized by the system described herein. Desktop sharing techniques and technologies are well known and, therefore, the basic operating principles of the desktop sharing application 214 will not be described in detail here. Generally, the desktop sharing application 214 is suitably designed to initiate, maintain, and manage desktop sharing sessions between a publisher device and one or more viewer devices, using any number of data communication connections and data communication networks as needed. A desktop sharing session allows each designated viewer device to view the desktop display of the publisher device in approximately real-time (subject to practical latencies exhibited by the data communication connections, networks, and device technology). Thus, the publisher device shares its display with the viewer devices by providing virtual display data to the viewer devices. The viewer devices receive the virtual display data, process the virtual display data using local resources and the respective instantiations of the desktop sharing application 214, and render a virtual or simulated version of the publisher's desktop using the respective display elements of the viewer devices.

The desktop sharing application 214 may also be responsible for establishing, maintaining, and tearing down the various data communication connections between the publisher device and the different viewer devices. In certain embodiments, the desktop sharing application 214 may establish, maintain, and tear down data communication connections with one or more server devices (see FIG. 1).

The desktop sharing application 214 may also be responsible for carrying out certain functions, operations, and methods that are related to the sharing features described in more detail below. For example, and without limitation, the desktop sharing application 214 at the publisher device may be executed to generate and render a graphical context menu and/or a graphical sharing control element that can be used to facilitate the sharing of files or other items. As another example, the desktop sharing application 214 at a viewer device may be executed to provide, enable, and disable a shared item folder to receive shared items from the publisher device.

The file system 216 may be implemented using well known and conventional software, firmware, and computer programming technologies. In accordance with well established principles, the file system 216 cooperates with the operating system of the device 200 to store, manage, and organize electronic data, files, folders, and other items. In this regard, the file system 216 may be utilized to support the desktop sharing file transfer methodologies described here. In certain embodiments, a user of the publisher device can locate and identify items to be shared by manipulating a graphical file folder structure maintained by the file system 216. Moreover, the file system 216 may be involved when the publisher device shares items or content with a viewer device.

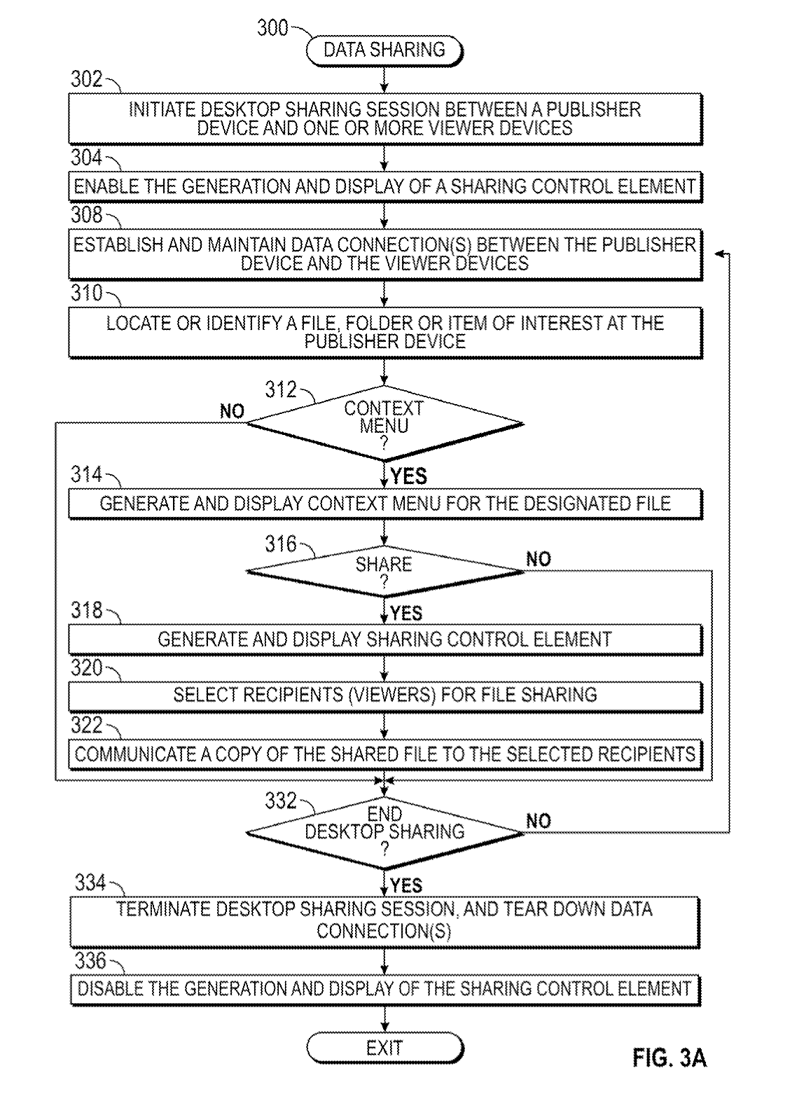

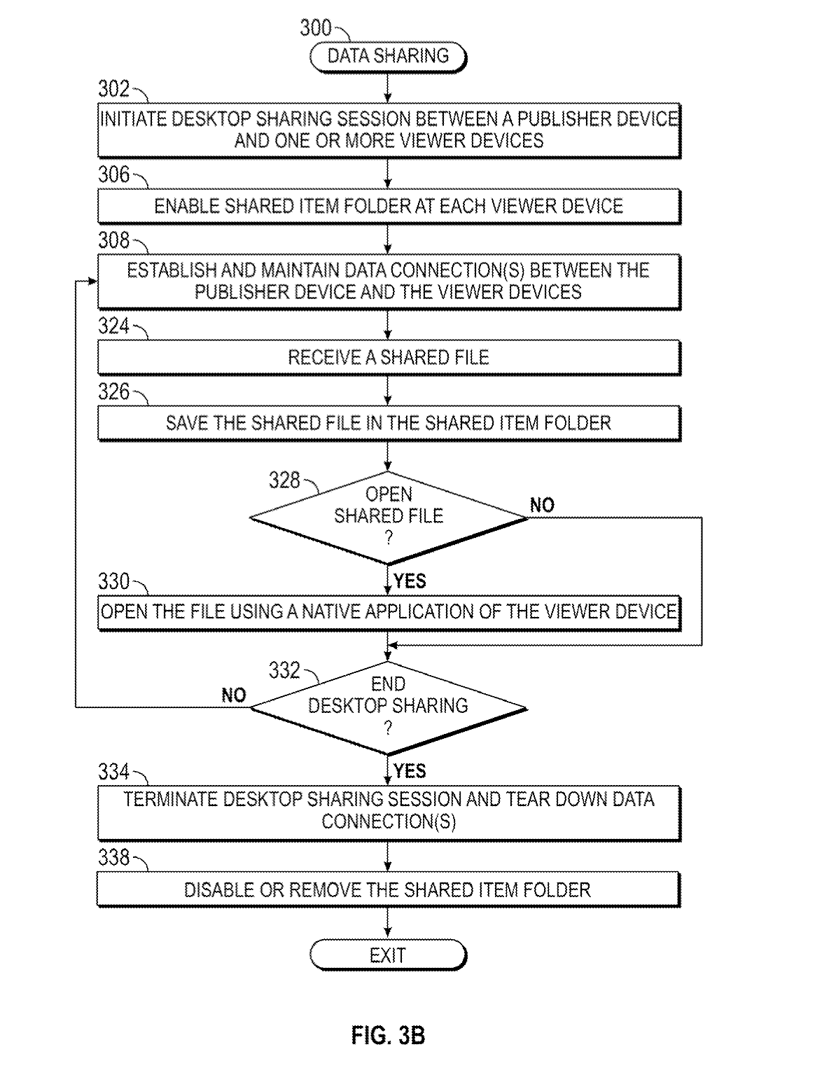

FIG. 3A and FIG. 3B are flow charts that illustrate an exemplary embodiment of a data sharing process 300, which may be performed in connection with a desktop sharing session. For ease of illustration, FIG. 3A corresponds to the process 300 as performed by the publisher device, and FIG. 3B corresponds to the process 300 as performed by the viewer device. The various tasks performed in connection with the process 300 may be performed by software, hardware, firmware, or any combination thereof. For illustrative purposes, the following description of the process 300 may refer to elements mentioned above in connection with FIG. 1 and FIG. 2. In practice, portions of the process 300 may be performed by different elements of the described system, e.g., a publisher device, a viewer device, a desktop sharing application, or the like. It should also be appreciated that the process 300 may include any number of additional or alternative tasks, the tasks shown in FIG. 3 need not be performed in the illustrated order, and the process 300 may be incorporated into a more comprehensive procedure or process having additional functionality not described in detail herein. Moreover, one or more of the tasks shown in FIG. 3 could be omitted from an embodiment of the process 300 as long as the intended overall functionality remains intact.

The illustrated embodiment of the process 300 begins by initiating and maintaining a desktop sharing session between the publisher device and one or more viewer devices (task 302). In practice, a user of the publisher device can launch the desktop sharing application, identify the viewer devices and/or the users of the viewer devices, and invite or otherwise prompt the users of the viewer devices to join the desktop sharing session. At the publisher device (see FIG. 3A), the process 300 enables the generation and display of a sharing control element (task 304) that can be used to facilitate the sharing of electronic items with one or more of the viewer devices. In certain embodiments, the sharing control element is only enabled when the desktop sharing session is active. Consequently, the sharing control element will normally remain hidden or will otherwise be inaccessible. In this regard, the sharing control element could be enabled/disabled with the opening/closing of the desktop sharing application or with the initiating/terminating of the desktop sharing session.

At each participating viewer device (see FIG. 3B), the process 300 enables a shared item folder for the viewer device (task 306). The viewer device saves received copies of shared items (i.e., items received from the publisher device during the desktop sharing session) in this shared item folder. In certain embodiments, the shared item folder is only enabled when the desktop sharing session is active. Consequently, the shared item folder will normally remain hidden or will otherwise be inaccessible. In this regard, the shared item folder could be enabled/disabled with the opening/closing of the desktop sharing application or with the initiating/terminating of the desktop sharing session.

In response to initiating the desktop sharing session, the process establishes and maintains one or more data communication connections between the publisher device and the participating viewer devices (task 308). The data communication connection(s) are used to support the desktop sharing session. Accordingly, any number of network links (wireless or tangible) could be established to create data connectivity between the publisher device and the viewer devices. As explained above, these data connections may be created using a network such as the Internet, and with the cooperation of a server infrastructure if needed or desired.

The data communication connection(s) can be used in an ongoing manner to convey the virtual display data that represents the displayed content of the publisher device, where the publisher device provides the virtual display data to the network, which in turn communicates the virtual display data to the viewer devices. Notably, the data communication connection(s) between the publisher device and each participating viewer device is preferably maintained in a persistent manner during the desktop sharing session to accommodate the sharing of files, data, folders, or content in a manner that does not rely on any other application installed at the publisher device or at the viewer devices. In other words, the existing data communication connection(s) that are already being used to convey the virtual display data are leveraged and used to transfer copies of items from the publisher device to the viewer devices (rather than transmitting the items using an email application, an FTP application, or the like).

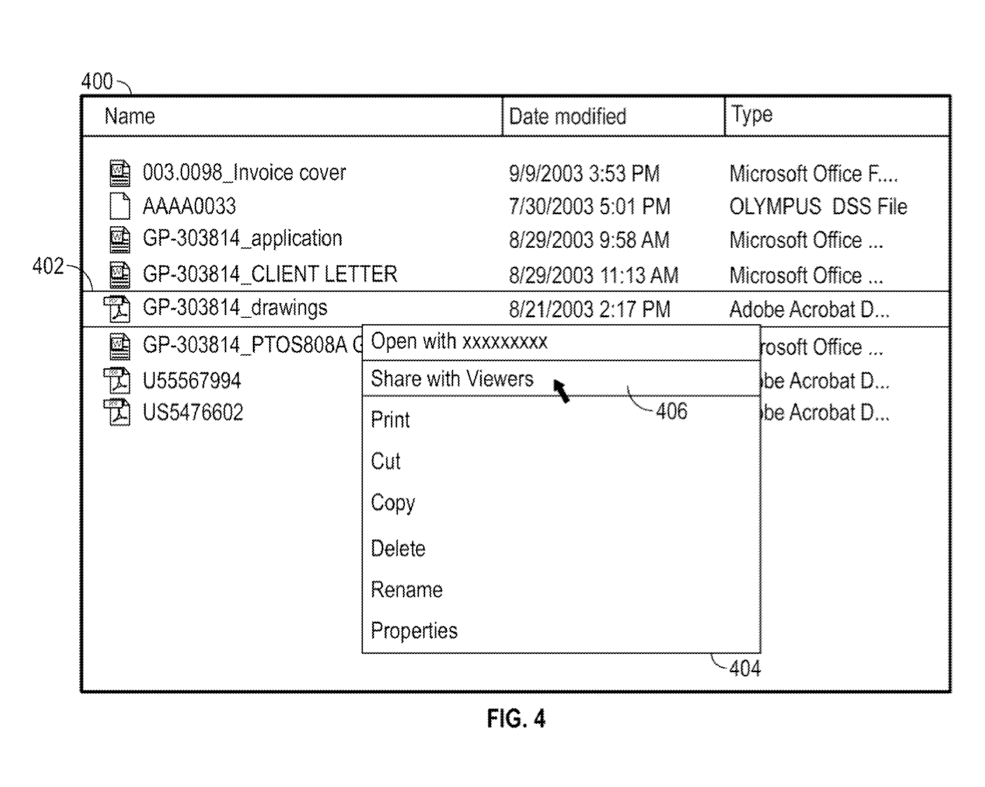

During the desktop sharing session, the user of the publisher device can work on various applications, access folders, open files, navigate the file system, and the like. During this time, the users of the viewer devices have virtual access to the display of the publisher device, due to the desktop sharing functionality. Referring to FIG. 3A, this example assumes that a user of the publisher device would like to share a file, folder, data, or other item of interest with one or more of the participating viewer devices. Thus, the process 300 may continue by locating or identifying a file, folder, or item at the publisher device (task 310). In practice, task 310 may be associated with user interaction with a graphical file browser, file explorer, file manager, or similar feature that provides a list of available files and folders. The user of the publisher device can traverse the displayed file/folder structure to locate and identify a file/folder to share with the viewer devices. In this regard, FIG. 4 depicts a portion of a graphical file list 400, which may be rendered for display at the publisher device. This example assumes that the user has identified one file 402 for sharing. Although this example refers to a particular file, any electronically represented item could be handled by the process 300. In this regard, the publisher device could share and transfer any type of item or data, including, without limitation: a file of any type and having any file extension; a file folder (with or without files contained therein); an executable file; a compressed file folder; or the like.

In accordance with the exemplary embodiment described here, the user of the publisher device is provided with a suitably configured and formatted sharing control element that allows the user to share one or more files with any of the participating viewer devices. Although the sharing control element could be provided in any number of different ways (e.g., a persistent window, a pop-up element, via a hot key), the example presented here employs a context menu to gain access to the sharing control element. Referring again to FIG. 3A, if the process 300 detects a context menu request for a designated item (the “Yes” branch of query task 312), then the publisher device generates and displays an appropriate context menu for the designated item (task 314). If a context menu request is not detected, then the process 300 may exit or proceed to a query task 332, which is described in more detail below.

A context menu request could be any command, instruction, control signal, user-initiated action, or the like, which launches the context menu for the designated item. For example, a context menu request may correspond to a “right click” action for a highlighted file, folder, or item. Alternatively, a context menu request may correspond to the hovering of a cursor over a file, folder, or item. FIG. 4 depicts an exemplary rendition of one possible context menu 404, which may be launched in response to the detection of a “right click” action for the highlighted file 402. As is well understood, the context menu 404 includes a number of entries that represent actions, commands, functions, or operations that can be carried out for the file 402. For this particular embodiment, the context menu 404 includes an entry 406 for a sharing control element (this entry 406 is labeled “Share with Viewers” in FIG. 4). Thus, selection or activation of the entry 406 causes the publisher device to render a graphical representation of a sharing control element.

Referring again to FIG. 3A, if the process 300 detects a share request or command (the “Yes” branch of query task 316), then the publisher device generates and displays the sharing control element (task 318). If a share request is not detected, then the process 300 may exit or proceed to query task 332. A share request could be any command, instruction, control signal, user-initiated action, or the like, which launches the sharing control element. For the illustrated embodiment, the share request corresponds to the selection or activation of the entry 406 (see FIG. 4), and the process initiates the display of the sharing control element in response to detecting user selection of the entry 406. Therefore, FIG. 4 depicts the following workflow at the publisher device: (1) open or access the file list 400; (2) identify and “right click” on the file 402; and select or click on the entry 406.

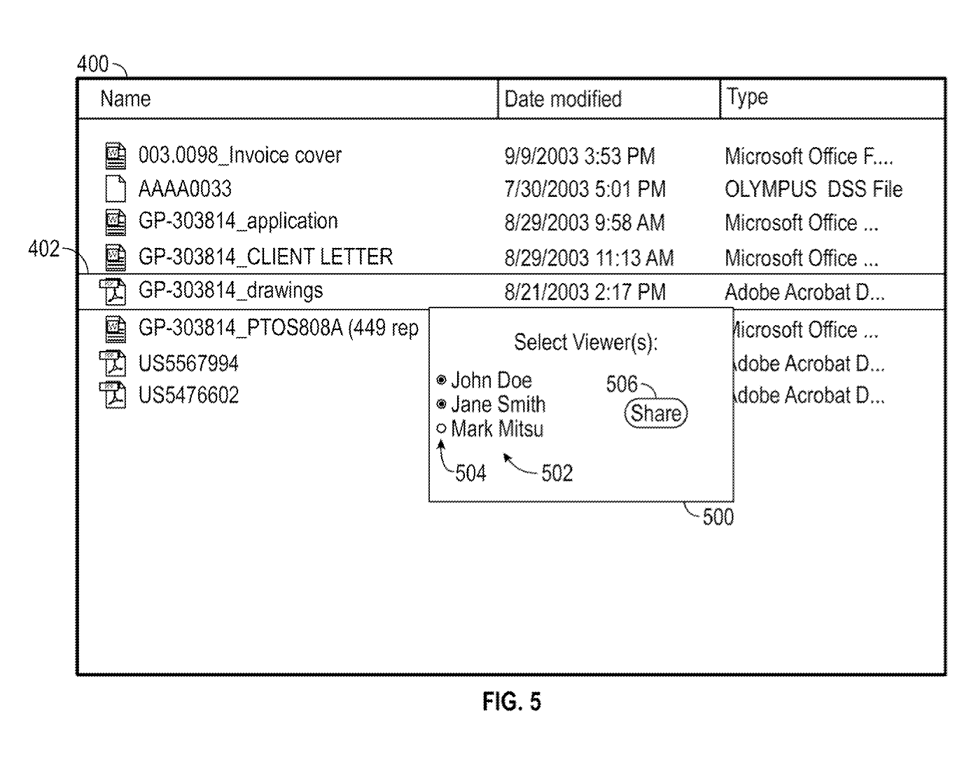

The specific format, content, and functionality of the sharing control element may vary from one embodiment to another, and from one device platform to another. Regardless of how it is implemented, however, the sharing control element accommodates selection of at least one item to be electronically shared with one or more viewer devices. For example, FIG. 5 depicts one possible embodiment of a sharing control element 500. This simplified example assumes that the sharing control element 500 is utilized to share the selected file 402 only. In alternative embodiments, the sharing control element 500 could be used to share a plurality of selected/highlighted files in a concurrent manner. In yet other embodiments, the sharing control element 500 could be provided with one or more controls that allow the user to browse for and “attach” additional files, folders, or items to share. Thus, the sharing control element 500 can support the sharing of any number of different items, depending on the specific implementation.

The illustrated embodiment of the sharing control element 500 includes a list 502 of potential recipients. Typically, the list 502 will identify all of the currently participating viewer devices (and/or the users of those viewer devices). In other words, the list 502 by default will identify any viewer device that is participating in the desktop sharing session. The illustrated example of the sharing control element 500 also includes control elements 504 (e.g., selectable radio buttons) that allow the user of the publisher device to select which viewer devices are to receive a copy of the shared file. FIG. 5 indicates that John Doe and Jane Smith have been selected as recipients of the shared file. In contrast, Mark Mitsu has not been selected as a recipient of the shared file. Accordingly, the publisher device will send the highlighted file only to John Doe and Jane Smith, even though Mark Mitsu remains a current participant of the desktop sharing session. Transfer of the shared file may be controlled via a GUI control element 506 of the sharing control element. Thus, after the user of the publisher device has identified the recipients of the shared file 402, one or more copies of the shared file 402 can be communicated after the user activates the GUI control element 506.

Referring again to FIG. 3A, the process 300 allows the user of the publisher device to select which recipients (viewer devices) are to receive the shared file (task 320). This allows the user of the publisher device to choose which, if any, viewer device will be able to access the shared file. Eventually, the process 300 communicates a copy of the designated item (and, if needed, related metadata) from the publisher device (task 322) in a manner that is intended to reach the identified recipients. In practice, copies of the shared files may be sent directly to a viewer device, or indirectly via a server device, as described previously. Notably, the file transfer can be accomplished using the desktop sharing configuration and the existing data communication connections that are currently being used to support the desktop sharing session. In other words, the file transfer need not rely on any external applications, FTP site, or the like. Instead, the user of the publisher device can simply activate a “Send” or “Share” button to automatically and transparently initiate the file transfer process in a quick and convenient manner.

In practice, the publisher device detects user interaction with the sharing control element and, in response to such interaction, communicates at least one shared file to one or more viewer devices. In this regard, FIG. 4 depicts the following workflow at the publisher device: (1) select the desired recipients or viewer devices; and (2) select or click on the GUI control element 506 to share the designated file 402.

Referring again to FIG. 3B, this example assumes that the viewer device receives a copy of the shared file (task 324) and saves the copy of the shared file in the shared item folder (task 326). Notably, the desktop sharing application resident at the viewer device independently controls the receiving and file transfer from the publisher device using the existing data communication connection(s), and preferably without relying on any other application installed at the viewer device. If the process 300 receives an instruction to open a shared file (the “Yes” branch of query task 328), then the viewer device opens the shared file using a native application of the viewer device (task 330).

If the process 300 receives an instruction or command to end the desktop sharing session (the “Yes” branch of query task 332), then the desktop sharing session is terminated and the associated data communication connections are removed or torn down (task 334). At the publisher device, the process 300 disables the generation and display of the sharing control element when the desktop sharing session is inactive or terminated (task 336, shown in FIG. 3A). At the viewer device, the process 300 disables or removes the shared item folder when the desktop sharing session is inactive or terminated (task 338, shown in FIG. 3B). If, however, the desktop sharing session is to remain active (the “No” branch of query task 332), then the process may exit or return to task 308 to continue as described above. Thus, additional files, folders, or items can be shared in an ongoing manner during the desktop sharing session.

The exemplary embodiments presented here relate to various computer-implemented and computer-executed techniques related to desktop sharing and the transfer of file from a publisher device to a viewer device (where both devices are participating in a desktop sharing session). The described subject matter could be implemented in connection with any suitable computer-based architecture, system, network, or environment, such as two or more user devices that communicate via a data communication network. Although the subject matter presented here could be utilized in connection with any type of computing environment, certain exemplary embodiments can be implemented in conjunction with a multi-tenant database environment.

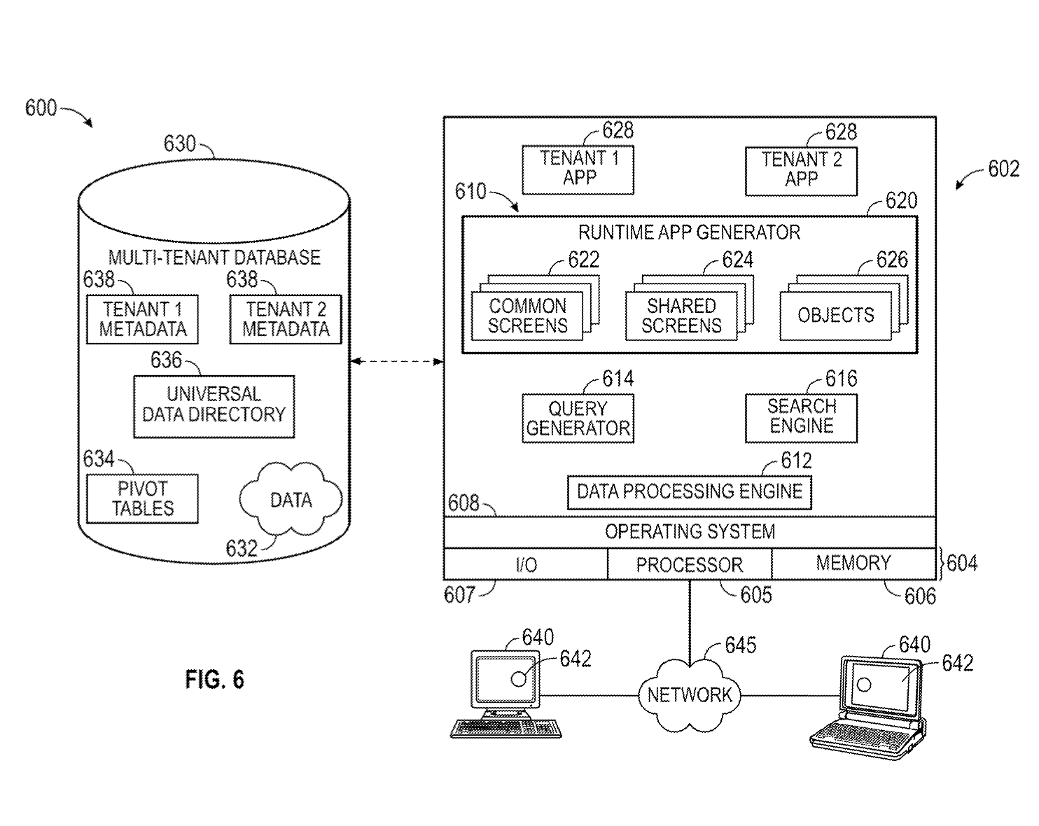

In this regard, an exemplary embodiment of a multi-tenant application system 600 is shown in FIG. 6. The system 600 suitably includes a server 602 that dynamically creates virtual applications 628 based upon data 632 from a common database 630 that is shared between multiple tenants. Data and services generated by the virtual applications 628 are provided via a network 645 to any number of user devices 640, as desired. Each virtual application 628 is suitably generated at run-time using a common application platform 610 that securely provides access to the data 632 in the database 630 for each of the various tenants subscribing to the system 600. In accordance with one non-limiting example, the system 600 may be implemented in the form of a multi-tenant CRM system that can support any number of authenticated users of multiple tenants.

A “tenant” or an “organization” generally refers to a group of users that shares access to common data within the database 630. Tenants may represent customers, customer departments, business or legal organizations, and/or any other entities that maintain data for particular sets of users within the system 600. Although multiple tenants may share access to the server 602 and the database 630, the particular data and services provided from the server 602 to each tenant can be securely isolated from those provided to other tenants. The multi-tenant architecture therefore allows different sets of users to share functionality without necessarily sharing any of the data 632.

The database 630 is any sort of repository or other data storage system capable of storing and managing the data 632 associated with any number of tenants. The database 630 may be implemented using any type of conventional database server hardware. In various embodiments, the database 630 shares processing hardware 604 with the server 602. In other embodiments, the database 630 is implemented using separate physical and/or virtual database server hardware that communicates with the server 602 to perform the various functions described herein.

The data 632 may be organized and formatted in any manner to support the application platform 610. In various embodiments, the data 632 is suitably organized into a relatively small number of large data tables to maintain a semi-amorphous “heap”-type format. The data 632 can then be organized as needed for a particular virtual application 628. In various embodiments, conventional data relationships are established using any number of pivot tables 634 that establish indexing, uniqueness, relationships between entities, and/or other aspects of conventional database organization as desired.

Further data manipulation and report formatting is generally performed at run-time using a variety of metadata constructs. Metadata within a universal data directory (UDD) 636, for example, can be used to describe any number of forms, reports, workflows, user access privileges, business logic and other constructs that are common to multiple tenants. Tenant-specific formatting, functions and other constructs may be maintained as tenant-specific metadata 638 for each tenant, as desired. Rather than forcing the data 632 into an inflexible global structure that is common to all tenants and applications, the database 630 is organized to be relatively amorphous, with the pivot tables 634 and the metadata 638 providing additional structure on an as-needed basis. To that end, the application platform 610 suitably uses the pivot tables 634 and/or the metadata 638 to generate “virtual” components of the virtual applications 628 to logically obtain, process, and present the relatively amorphous data 632 from the database 630.

The server 602 is implemented using one or more actual and/or virtual computing systems that collectively provide the dynamic application platform 610 for generating the virtual applications 628. The server 602 operates with any sort of conventional processing hardware 604, such as a processor 605, memory 606, input/output features 607 and the like. The processor 605 may be implemented using one or more of microprocessors, microcontrollers, processing cores and/or other computing resources spread across any number of distributed or integrated systems, including any number of “cloud-based” or other virtual systems. The memory 606 represents any non-transitory short or long term storage capable of storing programming instructions for execution on the processor 605, including any sort of random access memory (RAM), read only memory (ROM), flash memory, magnetic or optical mass storage, and/or the like. The server 602 typically includes or cooperates with some type of computer-readable media, where a tangible computer-readable medium has computer-executable instructions stored thereon. The computer-executable instructions, when read and executed by the server 602, cause the server 602 to perform certain tasks, operations, functions, and processes described in more detail herein. In this regard, the memory 606 may represent one suitable implementation of such computer-readable media. Notably, the processor 605 and the memory 606 may be suitably configured to carry out the various messaging and network-based features described above.

The input/output features 607 represent conventional interfaces to networks (e.g., to the network 645, or any other local area, wide area or other network), mass storage, display devices, data entry devices and/or the like. In a typical embodiment, the application platform 610 gains access to processing resources, communications interfaces and other features of the processing hardware 604 using any sort of conventional or proprietary operating system 608. As noted above, the server 602 may be implemented using a cluster of actual and/or virtual servers operating in conjunction with each other, typically in association with conventional network communications, cluster management, load balancing and other features as appropriate.

The application platform 610 is any sort of software application or other data processing engine that generates the virtual applications 628 that provide data and/or services to the user devices 640. The virtual applications 628 are typically generated at run-time in response to queries received from the user devices 640. For the illustrated embodiment, the application platform 610 includes a bulk data processing engine 612, a query generator 614, a search engine 616 that provides text indexing and other search functionality, and a runtime application generator 620. Each of these features may be implemented as a separate process or other module, and many equivalent embodiments could include different and/or additional features, components or other modules as desired.

The runtime application generator 620 dynamically builds and executes the virtual applications 628 in response to specific requests received from the user devices 640. The virtual applications 628 created by tenants are typically constructed in accordance with the tenant-specific metadata 638, which describes the particular tables, reports, interfaces and/or other features of the particular application. In various embodiments, each virtual application 628 generates dynamic web content (including GUIs, detail views, secondary or sidebar views, and the like) that can be served to a browser or other client program 642 associated with its user device 640, as appropriate.

The runtime application generator 620 suitably interacts with the query generator 614 to efficiently obtain multi-tenant data 632 from the database 630 as needed. In a typical embodiment, the query generator 614 considers the identity of the user requesting a particular function, and then builds and executes queries to the database 630 using system-wide metadata 636, tenant specific metadata 638, pivot tables 634, and/or any other available resources. The query generator 614 in this example therefore maintains security of the common database 630 by ensuring that queries are consistent with access privileges granted to the user that initiated the request.

The data processing engine 612 performs bulk processing operations on the data 632 such as uploads or downloads, updates, online transaction processing, and/or the like. In many embodiments, less urgent bulk processing of the data 632 can be scheduled to occur as processing resources become available, thereby giving priority to more urgent data processing by the query generator 614, the search engine 616, the virtual applications 628, etc. In certain embodiments, the data processing engine 612 and the processor 605 cooperate in an appropriate manner to perform and manage various techniques, processes, and methods associated with desktop sharing, as described previously with reference to FIGS. 1-5.

In operation, developers use the application platform 610 to create data-driven virtual applications 628 for the tenants that they support. Such virtual applications 628 may make use of interface features such as tenant-specific screens 624, universal screens 622 or the like. Any number of tenant-specific and/or universal objects 626 may also be available for integration into tenant-developed virtual applications 628. The data 632 associated with each virtual application 628 is provided to the database 630, as appropriate, and stored until it is requested or is otherwise needed, along with the metadata 638 that describes the particular features (e.g., reports, tables, functions, etc.) of that particular tenant-specific virtual application 628. For example, a virtual application 628 may include a number of objects 626 accessible to a tenant, wherein for each object 626 accessible to the tenant, information pertaining to its object type along with values for various fields associated with that respective object type are maintained as metadata 638 in the database 630. In this regard, the object type defines the structure (e.g., the formatting, functions and other constructs) of each respective object 626 and the various fields associated therewith. In an exemplary embodiment, each object type includes one or more fields for indicating the relationship of a respective object of that object type to one or more objects of a different object type (e.g., master-detail, lookup relationships, or the like).

In exemplary embodiments, the application platform 610, the data processing engine 612, the query generator 614, and the processor 605 cooperate in an appropriate manner to process data associated with a hosted virtual application 628 (such as a CRM application), generate and provide suitable GUIs (such as web pages) for presenting data on client devices 640, and perform additional techniques, processes, and methods to support the features and functions related to desktop sharing and related file transfer features and functions for the hosted virtual application 628.

Still referring to FIG. 6, the data and services provided by the server 602 can be retrieved using any sort of personal computer, mobile telephone, portable device, tablet computer, or other network-enabled user device 640 that communicates via the network 645. Typically, the user operates a conventional browser or other client program 642 to contact the server 602 via the network 645 using, for example, the hypertext transport protocol (HTTP) or the like. The user typically authenticates his or her identity to the server 602 to obtain a session identifier (“SessionID”) that identifies the user in subsequent communications with the server 602. When the identified user requests access to a virtual application 628, the runtime application generator 620 suitably creates the application at run time based upon the metadata 638, as appropriate. The query generator 614 suitably obtains the requested data 632 from the database 630 as needed to populate the tables, reports or other features of the particular virtual application 628. As noted above, the virtual application 628 may contain Java, ActiveX, or other content that can be presented using conventional client software running on the user device 640; other embodiments may simply provide dynamic web or other content that can be presented and viewed by the user, as desired.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a tangible non-transitory processor-readable medium in certain embodiments. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, or the like.

While at least one exemplary embodiment has been presented in the foregoing detailed description, it should be appreciated that a vast number of variations exist. For example, although the above description assumes that the publisher device functions as the sharing device, the desktop sharing application could be designed to also allow a viewer device to share files/folders with another viewer device and/or with the publisher device, using the existing data communication connections. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of sharing data in a computer-implemented system having a plurality of devices including at least a publisher device and a viewer device, the method comprising:
initiating a desktop sharing session between the publisher device and the viewer device;
establishing a data communication connection between the publisher device and the viewer device to support the desktop sharing session, wherein virtual display data representing displayed content of the publisher device is provided by the publisher device using the data communication connection;
displaying a sharing control element at the publisher device, the sharing control element accommodating selection of at least one item to be electronically shared with the viewer device;
detecting user interaction with the sharing control element, the user interaction corresponding to a selection of a designated item to be electronically shared with the viewer device; and
communicating a copy of the designated item from the publisher device using the data communication connection.

2. The method of claim 1, wherein communicating the copy of the designated item comprises transmitting the copy of the designated item from the publisher device to the viewer device using the data communication connection.

3. The method of claim 1, wherein communicating the copy of the designated item comprises transmitting the copy of the designated item from the publisher device to a server device of the computer-implemented system, the server device being communicatively coupled between the publisher device and the viewer device.

4. The method of claim 1, further comprising:
enabling generation and display of the sharing control element when the desktop sharing session is active; and
disabling generation and display of the sharing control element when the desktop sharing session is inactive.

5. The method of claim 4, wherein the enabling is performed in response to initiating the desktop sharing session.

6. The method of claim 1, wherein the designated item comprises an electronic file, an executable file, a file folder, or a compressed file folder.

7. The method of claim 1, further comprising:
detecting, at the publisher device, a context menu request for the designated item; and
initiating display of the sharing control element in response to detecting the context menu request.

8. The method of claim 1, further comprising:
detecting, at the publisher device, a context menu request for the designated item;
displaying a context menu for the designated item in response to detecting the context menu request, wherein the context menu includes an entry for the sharing control element;
detecting user selection of the entry; and
initiating display of the sharing control element in response to detecting the user selection of the entry.

9. The method of claim 1, wherein:
the sharing control element comprises a list of potential recipients that includes a user of the viewer device; and
the user interaction with the sharing control element includes selecting, from the list of potential recipients, the user of the viewer device.

10. The method of claim 9, wherein the list of potential recipients identifies participants in the desktop sharing session.

11. A method of sharing data in a computer-implemented system having a plurality of devices including at least a publisher device and a viewer device, the method comprising:
initiating a desktop sharing session between the publisher device and the viewer device;
establishing a data communication connection between the publisher device and the viewer device to support the desktop sharing session, wherein virtual display data representing displayed content of the publisher device is received by the viewer device using the data communication connection; and
during the desktop sharing session, receiving a copy of a designated item at the viewer device via the data communication connection, wherein the designated item is shared by the publisher device.

12. The method of claim 11, further comprising:
opening the copy of the item using a native application of the viewer device.

13. The method of claim 11, wherein the designated item comprises an electronic file, an executable file, a file folder, or a compressed file folder.

14. The method of claim 11, further comprising:
enabling a shared item folder at the viewer device when the desktop sharing session is active, wherein the viewer device saves received copies of shared items in the shared item folder; and
disabling the shared item folder at the viewer device when the desktop sharing session is inactive.

15. The method of claim 11, wherein:
initiating the desktop sharing session and establishing the data communication connection are executed by a desktop sharing application installed at the viewer device; and
the desktop sharing application controls the receiving of the copy of the designated item.

16. The method of claim 15, wherein the desktop sharing application independently controls the receiving of the copy of the designated item without relying on any other application installed at the viewer device.

17. A computer-implemented publisher device comprising a processor and a memory, wherein the memory comprises computer-executable instructions that, when executed by the processor, cause the publisher device to:
maintain a desktop sharing session with a viewer device, during which virtual display data representing displayed content of the publisher device is communicated to the viewer device over a data communication connection associated with the desktop sharing session;
display a sharing control element for a designated item to be shared by the publisher device, the sharing control element comprising a list of potential recipients that includes a user of the viewer device;
select the user of the viewer device from the list of potential recipients; and
communicate a copy of the designated item to the viewer device using the data communication connection.

18. The publisher device of claim 17, wherein the computer-executable instructions, when executed by the processor, cause the publisher device to:
detect a context menu request for the designated item; and
initiate display of the sharing control element in response to detecting the context menu request.

19. The publisher device of claim 17, wherein the publisher device provides the copy of the designated item using a desktop sharing application without relying on any other application installed at the publisher device.

20. The publisher device of claim 17, wherein the computer-executable instructions, when executed by the processor, cause the publisher device to:
enable generation and display of the sharing control element when the desktop sharing session is active; and
disable generation and display of the sharing control element when the desktop sharing session is inactive.
